(19) United States
(12) Patent Application Publication
(10) Pub. No.: US 2007/0076912 A1
(43) Pub. Date: Apr. 5, 2007

(54) Audio speaker enclosures

(76) Inventor: Richard D. Griffiths, Clinton, MD (US)

Correspondence Address: EPSTEIN & GERKEN, 1901 RESEARCH BOULEVARD, SUITE 340, ROCKVILLE, MD, 20850, US

(21) Appl. No.: 11/240,153

(22) Filed: Sep. 30, 2005

(51) Int. Cl. H04R 1/02

(52) U.S. Cl. 381/345

(57) ABSTRACT

An audio speaker enclosure includes a housing with a plurality of walls enclosing an interior and an opening in one of the walls for mounting an audio speaker. The walls are made in their entirety of a solid metal plate component comprising a planar plate having an interior surface facing the interior of the enclosure and an exterior surface facing the exterior of the enclosure, and a pattern of raised treads on the exterior surface of the plate. Each tread has a footprint on the exterior surface which is a modified diamond configuration. The plate component has areas of lesser thickness corresponding to the thickness of the plate and areas of greater thickness corresponding to the combined thickness of the plate and the tread.

### BACKGROUND OF THE INVENTION

1. Field of the Invention

The present invention relates generally to audio speaker enclosures and, more particularly, to subwoofer enclosures.

2. Brief Discussion of the Related Art

Speakers are a common component of audio systems and generally include driver mechanisms for converting electrical signals into audible sound. The standard speakers supplied with many conventional audio systems have driver mechanisms too small to effectively produce low bass frequencies, typically in the range of about 100 Hz and less, especially at higher volumes. Accordingly, specialized speakers known as subwoofers are oftentimes added to audio systems to produce the low bass frequencies that the standard speakers are either unable to produce or unable to produce cleanly at any significant volume. Subwoofers have larger driver mechanisms than the standard speakers to produce the low bass frequencies, and subwoofer driver mechanisms are usually 8 inches or larger in size.

In vehicle audio systems, the standard speakers normally have driver mechanisms 4 to 6½ inches in size essentially permanently mounted in interior structures of the vehicle such as doors, dashboards and/or body walls. The relatively small size driver mechanisms of the standard speakers in vehicle audio systems are inadequate to effectively produce the sound quality, volume and low bass frequencies which mobile audio enthusiasts desire. Subwoofers, therefore, have become an especially desirable and popular add-on to vehicle audio systems to obtain better sound quality, higher volume and lower bass frequencies than that obtainable from the standard speakers.

Various types of speaker enclosures, including sealed and vented enclosures, have been proposed for mounting subwoofers. A sealed enclosure generally comprises a completely sealed box-like structure having a wall on which the subwoofer is mounted. Normally the subwoofer is mounted on the enclosure wall with a front end of the subwoofer facing to the exterior of the enclosure and a rear end of the subwoofer disposed in the interior of the enclosure such that sound waves emanating from the rear end are isolated from sound waves emanating from the front end. A sealed enclosure is advantageous for vehicle use because of its flatter frequency response curve considering the 12 dB/octave rise in response below 60-80 Hz associated with vehicle cabin gain, excellent transient characteristics and high power handling. A vented or ported enclosure is similar to a sealed enclosure except for the addition of a vent or port, oftentimes a length of PVC pipe, extending through a wall of the enclosure to provide communication between the interior of the enclosure and the environment exterior to the enclosure. The port can be tuned to a certain frequency by varying its length and cross-sectional area such that the sound waves emanating from the rear end of the subwoofer are used to reinforce the sound waves emanating from the front end of the subwoofer. It is desirable in vented enclosures for the frequency response curve to be as flat as possible considering vehicle cabin gain.

The size of the subwoofers is one factor influencing the overall external size required for the enclosures. Since subwoofers tend to be relatively heavy, it is also necessary that the enclosures be sufficiently strong and rigid to properly mount and support the subwoofers. It is beneficial for the external size and/or weight of subwoofer enclosures to be minimized so far as possible, without sacrificing structural integrity and sound output, in order to reduce the amount of space taken up by the enclosures, to provide greater economy of materials and cost, and to make it easier to transport the enclosures. For vehicle use, it is especially beneficial for the external size of subwoofer enclosures to be minimized given the limited amount of space available in vehicles. It is also beneficial for subwoofer enclosures to be simplified in structure and assembly to reduce material costs and/or production costs. Furthermore, it is beneficial that subwoofer enclosures be distinctive in appearance to appeal to the discriminating aesthetic taste of audio enthusiasts, particularly mobile audio enthusiasts. Unfortunately, many conventional subwoofer enclosures incorporate materials and/or designs that restrict reductions in enclosure weight and/or external size, compromise structural integrity and/or sound output, involve complex structure and/or assembly translating into increased costs, and/or lack aesthetic distinction.

Most typically, conventional subwoofer enclosures have been made from planar sheets or panels of rigid wood materials including solid wood and wood composites, such as ¾ inch thick MDF (medium density fiberboard). Each wall of the enclosure is typically cut to size and shape from a sheet or panel of the wood material, with the walls being assembled to form the enclosure by connecting the walls along their peripheral edges using screws and glue. Enclosures of this type tend to be heavy and large in external size due to the considerable thickness of the sheets and the weight of the wood material. In addition to wood materials being high in cost, enclosures made from wood material are expensive due to the increased time and labor required to assemble the walls using screws and glue. The joints or seams at which the peripheral edges of the walls are connected are prone to air leakage, thereby compromising the sealed aspect of the enclosures. Enclosures made of wood materials tend to crack and warp, and may experience considerable distortion from thermal expansion and contraction. The exterior surfaces of the walls must usually be finished, for example by sanding, priming, painting and/or staining, and the finishing process adds further to the end cost of enclosures made from wood material. The exterior surfaces of the walls are ordinarily uniformly flat or planar and, even when the exterior surfaces of the walls are finished, enclosures made from wood material remain aesthetically indistinctive and unexciting in appearance or “look”.

U.S. Pat. No. 4,690,244 to Dickie relates to a speaker enclosure having walls comprising wood panels and having a stiffening structure made of cardboard in the interior of the enclosure defining cells containing blocks of foam. Besides having the aforementioned disadvantages of enclosures made from wood material, the enclosure disclosed by Dickie has the additional drawbacks of increased complexity and greater cost of materials and assembly due to the stiffening structure and blocks of foam.

U.S. Pat. No. 4,231,446 to Weiss et al discloses a speaker enclosure made of sheet aluminum. The sheet aluminum is required to be resilient and not rigid since the back wave emanating from the rear end of the speaker is utilized to vibrate the enclosure. The resilient sheet aluminum is distinguished from rigid materials, such as veneered chipboard, and a speaker enclosure made of the resilient sheet aluminum is thusly not suitable to support the weight of heavy speakers such as subwoofers.

It has been proposed to form one or more walls of a speaker enclosure of a multi-layer composite in which one or more layers of the composite is/are metal as represented by U.S. Pat. No. 4,284,168 to Gaus and U.S. Pat. No. 4,811,403 to Henricksen et al. Multi-layer composites will generally be higher in cost than uniform materials, and walls made from composite materials may be more difficult to assemble than those made from uniform materials.

U.S. Pat. No. 6,719,090 B2 to Tracy relates to a small size speaker enclosure in which some, but not all, of the walls of the enclosure are made of aluminum. The speaker enclosure is not suitable for a subwoofer and is not sealed in the manner of a sealed or vented enclosure.

A subwoofer enclosure made of aluminum is disclosed in U.S. Pat. No. 6,801,633 B2 to Tracy. The enclosure has the disadvantage of requiring an extraneous structural component in the form of a baffle within the interior of the enclosure for mounting the subwoofer.

U.S. Patent Application Publication No. 2003/0161495 A1 to Nevill et al discloses a speaker enclosure that can be made of aluminum but also requires extraneous structural components in the interior of the enclosure.

### SUMMARY OF THE INVENTION

The present invention is generally characterized in an audio speaker enclosure comprising a housing including a plurality of walls enclosing an interior and an opening in one of the walls for mounting an audio speaker. Each of the walls is made in its entirety of an aluminum plate component comprising a plate having an interior surface facing the interior of the housing and an exterior surface facing to the exterior of the housing, and a plurality of treads on the exterior surface of the plate. The plate and treads are formed monolithically of solid aluminum. The plate has a uniform thickness between the exterior and interior surfaces. The treads have a uniform thickness between the exterior surface of the plate and top surfaces of the treads raised or elevated from the exterior surface of the plate. Each tread has a side wall extending angularly outwardly from a peripheral edge of its top surface to the exterior surface of the plate. The plate component has areas of lesser thickness corresponding to the thickness of the plate without the treads and areas of greater thickness corresponding to the combined thickness of the plate and the tread. The treads impart strength and rigidity to the plate, allowing the thickness of the housing walls to be minimized and still provide sufficient structural integrity to support an audio speaker including a subwoofer audio speaker.

Another aspect of the present invention pertains to the housing walls being made in their entireties from a solid metal plate component comprising a plate and a plurality of raised treads wherein each tread has a footprint on the plate in a modified diamond configuration. The plate has an interior surface facing the interior of the housing and an exterior surface facing to the exterior of the housing, and the treads are disposed on the exterior surface of the plate. Each tread includes a top surface having a peripheral edge, a side wall extending angularly outwardly from the peripheral edge of the top surface to the exterior surface of the plate, and a base at which a lower peripheral edge of the side wall is joined to the exterior surface of the plate. The lower peripheral edge of the side wall defines the tread footprint and is symmetrical to a major axis bisecting the tread lengthwise and to a minor axis perpendicular to the major axis and bisecting the tread widthwise. The lower peripheral edge includes first and second base side edges which are mirror images of one another on opposite sides of the major axis. The first base side edge has opposed ends joined respectively to opposed ends of the second base side edge at base end points along the major axis. Each of the first and second base side edges has a curved central segment between a pair of curved end segments, which are more gently curved than the central segment. Each of the treads has a maximum length between the base end points and a maximum width between base side points of the first and second base side edges, respectively, along the minor axis.

In yet another aspect of the present invention, an audio speaker enclosure comprises a housing including a front wall, a back wall, a top wall, a bottom wall, a left side wall and a right side wall enclosing an interior, and an opening in the front wall for receiving an audio speaker. The housing is formed from a plurality of metal plate component parts each having an initially planar condition and being bent from the initially planar condition to form a plurality of the walls. The plate component parts have peripheral edges joined by welding to form the housing. Each of the plate component parts is made in its entirety of solid aluminum and comprises a plate having an interior surface facing the interior of the housing and an exterior surface facing to the exterior of the housing, and a pattern of raised treads on the exterior surface.

Various objects, benefits and advantages of the present invention will become apparent from the following detailed description taken in conjunction with the accompanying drawings.

### BRIEF DESCRIPTION OF THE DRAWINGS

FIG. 1 is a front perspective view of a speaker unit including a speaker enclosure according to the present invention.

FIG. 2 is a back perspective view of the speaker unit of FIG. 1.

FIG. 3 is an exploded, front perspective view of the speaker unit of FIG. 1.

FIG. 4 is an exploded, side perspective view of the speaker enclosure for the speaker unit of FIG. 1.

FIG. 5 is a broken, front perspective view of the speaker unit of FIG. 1 showing a portion of the speaker enclosure wherein a seam joins abutting peripheral edges of walls of the speaker enclosure.

FIG. 6 is a broken, top perspective view of a plate component used to form the walls of the speaker enclosure for the speaker unit of FIG. 1.

FIG. 7 is a broken, top plan view of the plate component showing an upper surface of a plate of the plate component and a tread of the plate component disposed on the upper surface of the plate.

FIG. 8 is a broken view, partly in section, of the plate component taken along line 8-8 of FIG. 6.

FIG. 9 is a broken view, partly in section, of the plate component taken along line 9-9 of FIG. 6.

FIG. 10 is a front perspective view of an alternative speaker unit comprising an alternative speaker enclosure according to the present invention.

### DESCRIPTION OF THE PREFERRED EMBODIMENTS

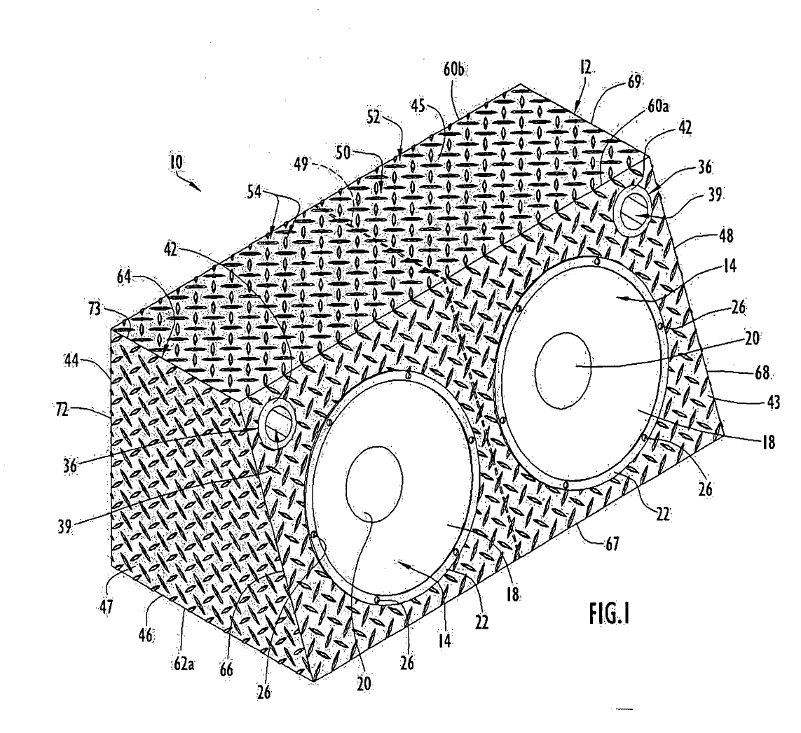

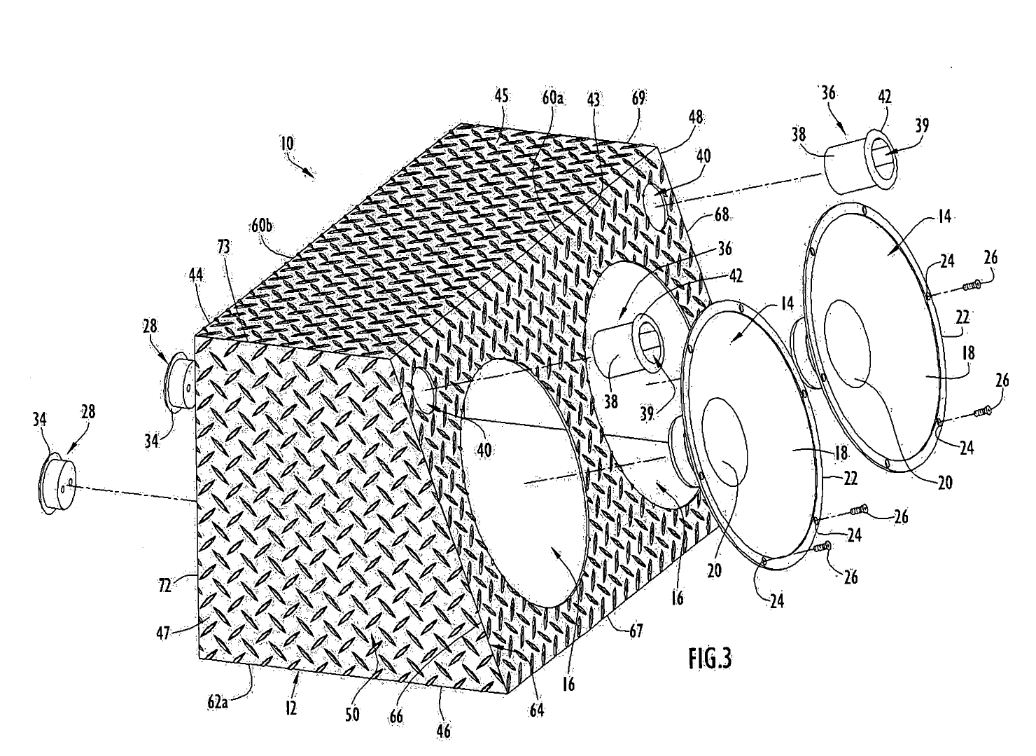

FIGS. 1-3 illustrate an audio speaker unit 10 comprising a speaker enclosure 12 according to the present invention and one or more speakers 14 mounted to the speaker enclosure 12. The speaker enclosure 12 includes a box-like housing having a plurality of walls enclosing an interior. One of the walls is provided with one or more openings 16 for respectively mounting the one or more speakers 14 as shown in FIG. 3. The speaker unit 10 is depicted as a dual speaker unit having two speakers 14 mounted in corresponding openings 16 in a front wall of enclosure 12. Where the speaker unit 10 is a single speaker unit, one opening 16 can be provided in the wall of the enclosure 12 for mounting one speaker 14.

Any conventional loudspeakers having driver mechanisms capable of converting electrical signals into audible sound can be used for the one or more speakers 14. However, the speaker enclosure 12 is particularly advantageous for mounting speakers known as subwoofers. Subwoofers are loudspeakers having relatively large size driver mechanisms capable of producing the low bass frequencies, typically about 100 Hz and lower, that the relatively smaller size driver mechanisms of standard loudspeakers are ineffective to produce. The driver mechanisms of conventional subwoofers commonly include cones, and conventional subwoofers are usually available with cones of various sizes, typically 8 inches in diameter and larger. Each speaker 14 of speaker unit 10 is depicted as a subwoofer having a driver mechanism including a cone 18 and a driver 20 at the narrow rear end of the cone 18. A mounting flange 22 circumscribes the wider front end of the cone 18 which defines the diameter or size of the cone, and the cone diameter at its wider front end is typically used to designate the size of the subwoofer. The openings 16 in enclosure 12 are sized to respectively receive the front ends of the cones 18 with a close fit, with the rear ends of the cones disposed in the interior of the enclosure and the mounting flanges 22 disposed externally of the enclosure in close overlapping relation with the wall of the enclosure. Holes 24 may be provided in the mounting flanges 22 at spaced locations to respectively receive fasteners 26, such as screws, used to secure the mounting flanges to the wall of enclosure 12 as shown in FIG. 1, only two screws 26 being shown in FIG. 3 for each mounting flange 22. If necessary, holes can be provided in the wall of the enclosure 12 in correspondence with the holes 24 to facilitate threaded advancement of the screws 26 into the wall of the enclosure. Various sealants may be used to seal the mounting flanges 22 to the enclosure 12 in air-tight relation.

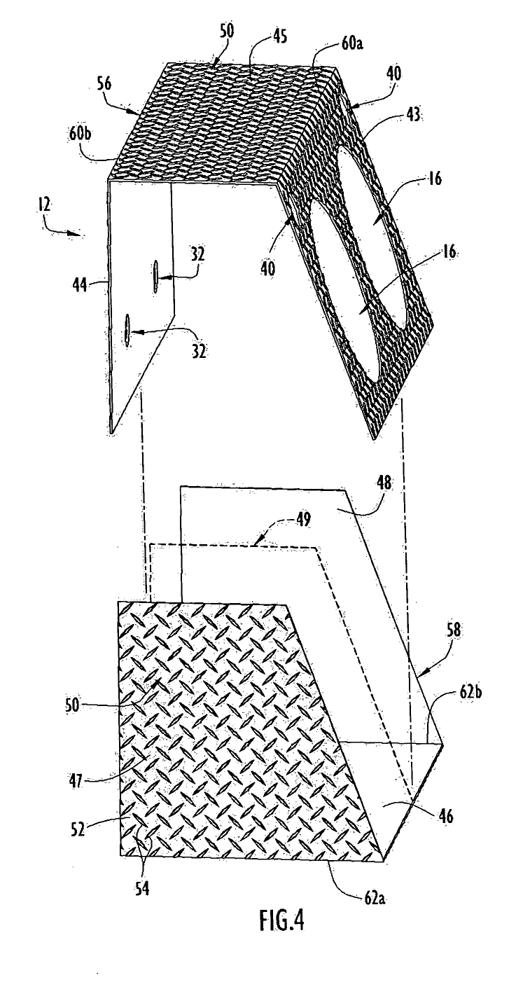

The speaker unit 10 may include an electrical connector 28 for each speaker 14, and the drivers 20 of speakers 14 can be electrically connected to the respective connectors 28 via appropriate wiring. The electrical connectors 28 can have terminals 30 for electrical connection with a standard external sound source via appropriate wiring to provide electrical signals to the drivers 20. As best shown in FIG. 3, the electrical connectors 28 may be disposed with a close fit in respective apertures 32 in a wall of enclosure 12, the apertures 32 being shown formed in the back wall of the enclosure in FIG. 4, and the connectors 28 may include peripheral rims 34 for overlapping the wall of the enclosure 12 externally in close relation therewith. Various sealants may be used to seal the rims 34 to the wall of the enclosure 12 in air-tight relation. Since the structure and operation of loudspeakers in general and subwoofers in particular is known in the art, the structure and operation of speakers 14 and their sound source connections are not described herein in any further detail.

The enclosure 12 for speaker unit 10 is depicted as a vented or ported speaker enclosure wherein the box-like housing of enclosure 12 with the speakers 14 and electrical connectors 28 assembled thereto is sealed except for a vent or port 36 for each speaker 14. As best seen in FIG. 3, each vent 36 can comprise a tubular member 38 of appropriate length and defining a passage 39 therethrough of appropriate cross-sectional area or size to provide communication between the interior of the enclosure 12 and the environment exterior to the enclosure 12. As shown in FIG. 3, a hole 40 is provided in a wall of enclosure 12 for each tubular member 38, the hole 40 having a size and configuration to receive the external cross-section of the corresponding tubular member 38 therethrough with a close fit. Each tubular member 38 is received in its corresponding hole 40 to extend through the wall of enclosure 12 with a rear end of the tubular member 38 positioned in the interior of the enclosure to receive sound waves emanating from the rear end of the corresponding speaker 14 and with a circumferential lip 42 at a front end of the tubular member 38 overlapping the wall of enclosure 12 externally in close relation therewith. The holes 40 for tubular members 38 are seen as being provided in the front wall of enclosure 12 so that the sound waves emanating from the rear ends of the speakers 14 exit the front ends of the tubular members along the front wall to reinforce the sound emanating from the front ends of the speakers along the front wall. Each tubular member 38 and/or lip 42 can be sealed to the wall of the enclosure in air-tight relation using any suitable sealant. Each tubular member 38 can be a length of PVC pipe of appropriate inside and outside diameters.

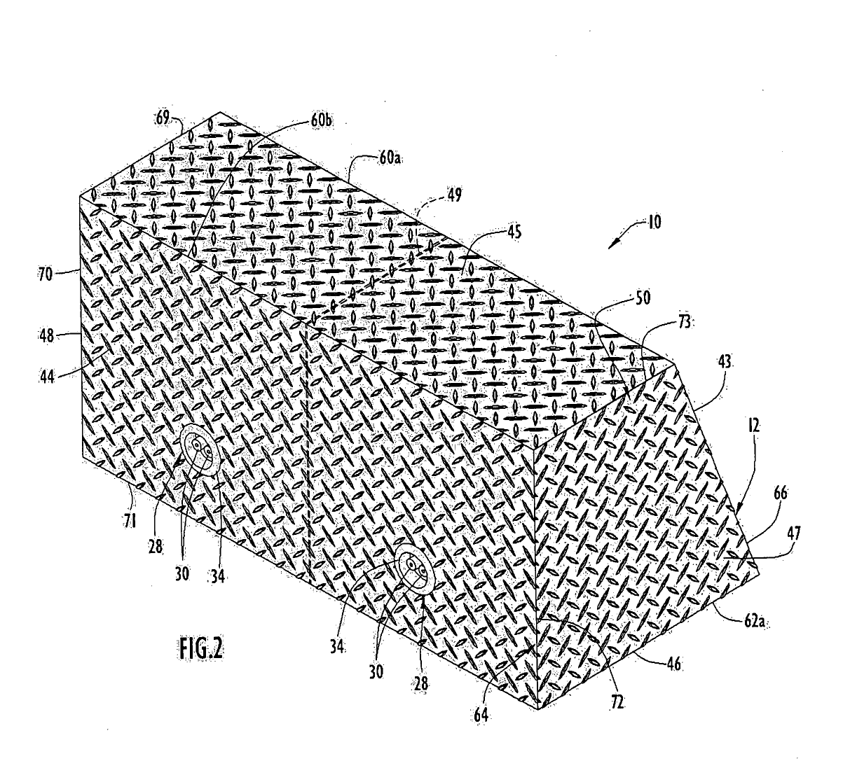

In FIGS. 1 and 2, the speaker unit 10 is shown in a completely assembled condition wherein the speakers 14, electrical connectors 28 and vents 36 are assembled to the enclosure 12 to form a dual vented speaker unit. The speaker unit 10 is shown in a completely unassembled condition in FIG. 3 wherein the speakers 14, electrical connectors 28 and vents 36 are not assembled to the enclosure 12. The speaker unit 10 can be sold completely assembled or can be sold less than completely assembled or partially assembled. The enclosure 12 can be sold with or without any or all of the speakers 14, electrical connectors 28 and vents 36 assembled thereto. Any or all of the speakers 14, electrical connectors 28 and vents 36 can be provided independently of the enclosure 12 and/or can be assembled to the enclosure 12 by the end user. For example, the enclosure 12 can be sold with the electrical connectors 28 and vents 36 assembled thereto but without the speakers 14 assembled thereto, in which case the speakers 14 can be provided by and/or assembled to the enclosure 12 by the end user. The enclosure 12 can be provided with openings 16, apertures 32 and/or holes 40 sized to receive standard speakers 14, electrical connectors 28 and/or vents 36. Accordingly, various interchangeable speakers 14, electrical connectors 28 and/or vents 36 can be assembled to the enclosure 12 to form a speaker unit.

When the speakers 14, electrical connectors 28 and vents 36 are assembled to the enclosure 12 to form the speaker unit 10, the interior of the enclosure 12 is completely sealed or isolated from the environment exterior to the enclosure 12 except for the passages 39 of vents 36. The vented or ported speaker unit 10 operates in the same manner as conventional vented speaker units, with the vents 36 providing a path for the sound waves that emanate from the rear end of the corresponding speakers 14 to pass through the vents and reinforce the sound waves that emanate from the front end of the corresponding speakers 14. The enclosure 12 can include a single vent 36 where the speaker unit 10 has a single speaker 14, i.e. single vented speaker unit, and the enclosure 12 can be provided without vents where the enclosure is an entirely sealed or non-vented enclosure as described further below.

Enclosure 12 is illustrated assembled in FIGS. 1-3 and is illustrated unassembled in FIG. 4. The assembled enclosure 12 forms the box-like housing which includes a front wall 43, a back wall 44, a top wall 45, a bottom wall 46, a left side wall 47 and a right side wall 48. All of the walls can be flat or planar in extent with straight peripheral or perimeter edges. In the configuration shown for enclosure 12, the top wall 45 is parallel to the bottom wall 46. The left and right side walls 47 and 48 are parallel to one another and perpendicular to the top and bottom walls 45 and 46. Top peripheral edges of the left and right side walls 47 and 48 are respectively connected to left and right side peripheral edges of the top wall 45. Bottom peripheral edges of the left and right side walls 47 and 48 are respectively connected to left and right side peripheral edges of the bottom wall 46. The front wall 43 has a top peripheral edge connected to a front peripheral edge of top wall 45, left and right side peripheral edges respectively connected to front peripheral edges of the left and right side walls 47 and 48, and a bottom peripheral edge connected to a front peripheral edge of bottom wall 46. The back wall 44 has a top peripheral edge connected to a back peripheral edge of top wall 45, left and right side peripheral edges respectively connected to back peripheral edges of left and right side walls 47 and 48, and a bottom peripheral edge connected to a back peripheral edge of bottom wall 46.

The front wall 43 has the openings 16 formed therein at appropriate locations for receiving the speakers 14. In enclosure 12, the openings 16 have centers located the same distance downwardly from the top wall 45 and the same distance inwardly from the left and right side walls 47 and 48, respectively. The openings 16 are each circular for accommodating the front end of the cone 18 therein with the mounting flange 22 closely overlapping the front wall 43 externally as described above. The holes 40 are formed in front wall 43 at appropriate locations to receive vents 36. In enclosure 12, the holes 40 are located near the upper left and upper right corners of the front wall 43. The holes 40 have centers spaced the same distance downwardly from the top wall 45 and the same distance inwardly from the left and right side walls 47 and 48, respectively. The apertures 32 for receiving electrical connectors 28 are formed in back wall 44 at suitable locations. In enclosure 12, the apertures 32 are formed in back wall 44 closer to the bottom wall 46 than to the top wall 45. The apertures 32 have centers located the same distance upwardly from the bottom wall 46 and the same distance inwardly of the left and right side walls 47 and 48, respectively.

The depth of the enclosure 12 from front to back is greater at its bottom than at its top for enhanced stability against tipping when the bottom wall 46 is supported on a support surface. Accordingly, the front wall 43 extends angularly outwardly from the top wall 45 to the bottom wall 46 in a forward direction. The angle of the front wall 43 also provides the benefit of optimally positioning the speaker cones 18 and vents 36 to emanate sound from the front of the enclosure 12. The front peripheral edges of the left and right side walls 47 and 48 are thusly slanted or angled outwardly from top to bottom in the forward direction in accordance with the outward angle of the front wall 43. The back wall 44 can be perpendicular to the top and bottom walls 45 and 46 as depicted for enclosure 12, in which case the back peripheral edges of the left and right side walls 47 and 48 are perpendicular to the top and bottom peripheral edges of the left and right side walls 47 and 48. However, it should be appreciated that the back wall 44 could extend angularly outwardly from the top wall 45 to the bottom wall 46 in a direction opposite the front wall 43, i.e. in a rearward direction, in which case the back peripheral edges of the left and right side walls 47 and 48 can be slanted or angled outwardly from top to bottom in accordance with the outward angle of the back wall. The periphery or perimeter of bottom wall 46 defines a footprint for the enclosure 12 on the support surface that supports the enclosure via its bottom wall 46. For vehicle or automotive use, the bottom wall 46 will normally be supported on an available support surface in the vehicle, such as the floor surface in an automobile trunk or other cargo or storage area. Furthermore, the height, width and depth dimensions of the enclosure determine the volume of space needed to accommodate the enclosure.

Each wall of enclosure 12 is made in its entirety from a rigid metal plate component 50 comprising a flat or planar plate 52 and a pattern of raised treads 54 on an exterior surface of the plate 52. The plate component 50 is made in its entirety of metal, preferably aluminum, and is explained in greater detail below. Each of the enclosure walls 43, 44, 45, 46, 47 and 48 can be individually cut to peripheral size and shape from a sheet of plate component 50, with adjacent or abutting peripheral edges of the walls being joined, preferably by welding, to form the enclosure 12. In order to reduce the number of separate parts and the number of seams at which peripheral edges of the enclosure walls must be joined, it is preferred that multiple walls of the enclosure 12 be formed by bending a single, initially planar piece of plate component 50, the single piece of plate component 50 constituting a single plate component part. As shown in FIG. 4, the enclosure 12 may be formed from two plate component parts 56 and 58, each bent from an initially flat or planar condition to form a plurality of the walls of the enclosure 12. Plate component part 56 is bent at bends 60a and 60b from an initially flat or planar condition to form front wall 43, back wall 44 and top wall 45. Bend 60a defines the top peripheral edge of front wall 43 as well as the front peripheral edge of top wall 45, the front wall 43 being bent from the plane of top wall 45 at an angle less than 90° to obtain the outward angle for the front wall 43 in the forward direction. Bend 60b defines the back peripheral edge of top wall 45 as well as the top peripheral edge of back wall 44, the back wall 44 being bent from the plane of top wall 45 at an angle of or about 90° to be oriented perpendicular or substantially perpendicular to the top wall 45. The plate component part 56 is an integral and unitary, one-piece, monolithic part such that the front wall 43, back wall 44 and top wall 45 are formed integrally, unitarily or monolithically as one piece. The plate component part 58 is bent at bends 62a and 62b from an initially flat or planar condition to form bottom wall 46, left side wall 47 and right side wall 48. Bend 62a defines the left side peripheral edge of bottom wall 46 as well as the bottom peripheral edge of left side wall 47. Bend 62b defines the right side peripheral edge of bottom wall 46 as well as the bottom peripheral edge of right side wall 48. The plate component part 58 is an integral and unitary, one-piece, monolithic part such that the bottom wall 46, the left side wall 47 and the right side wall 48 are formed integrally, unitarily or monolithically as one piece.

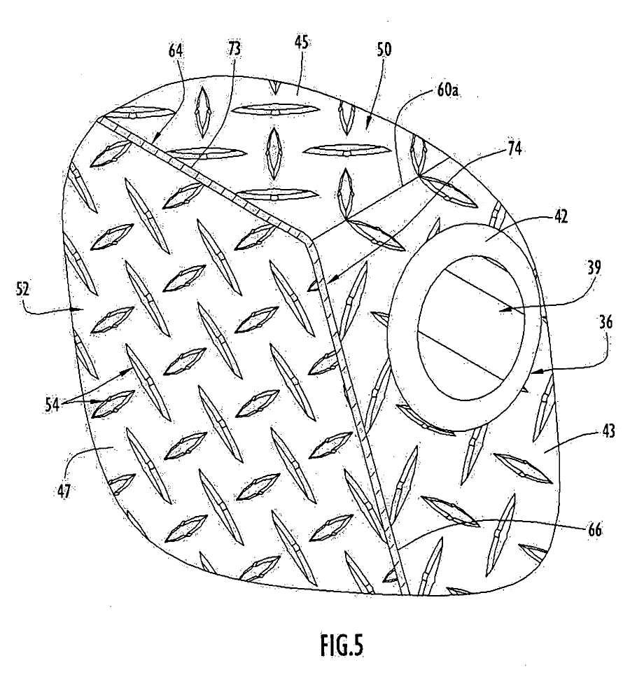

The plate component parts 56 and 58 are joined to one another along their peripheral or perimeter edges to form the enclosure 12, the peripheral edges of the plate component parts preferably being joined by welding. The peripheral edges of plate component parts 56 and 58 are joined to one another along a continuous seam 64 made up of a front left side seam segment 66 joining the left side peripheral edge of front wall 43 to the front peripheral edge of left side wall 47, a front bottom seam segment 67 joining the bottom peripheral edge of front wall 43 to the front peripheral edge of bottom wall 46, a front right side seam segment 68 joining the right side peripheral edge of front wall 43 to the front peripheral edge of right side wall 48, a top right side seam segment 69 joining the right side peripheral edge of top wall 45 to the top peripheral edge of right side wall 48, a back right side seam segment 70 joining the right side peripheral edge of back wall 44 to the back peripheral edge of right side wall 48, a back bottom seam segment 71 joining the bottom peripheral edge of back wall 44 to the back peripheral edge of bottom wall 46, a back left side seam segment 72 joining the left side peripheral edge of back wall 44 to the back peripheral edge of left side wall 47, and a top left side seam segment 73 joining the left side peripheral edge of top wall 45 to the top peripheral edge of left side wall 47. FIG. 5 depicts the seam 64 formed by a welded joint 74. The entire seam 64 can be formed by one continuous, unbroken welded joint 74. However, it should be appreciated that the seam 64 can be composed of a plurality of welded joints formed separately and individually. It should also be appreciated that the plate component parts 56 and 58 can be cut from a sheet of plate component 50 in various alternative configurations and can be bent or folded in various alternative ways to define various alternative combinations of walls of the enclosure 12. In addition, the plate component parts 56 and 58 can fit together in various alternative ways for their peripheral edges to be joined, preferably by welding, to form the enclosure 12.

Where the enclosure 12 is provided with openings 16 for two speakers 14, the enclosure 12 can include a partition wall 49 centrally disposed between speakers 14 and dividing the interior of the enclosure into left and right sealed compartments respectively housing the rear ends of speakers 14 as represented in dotted lines in FIGS. 1 and 2 and in solid lines in FIG. 4. The partition wall 49 can be planar and can have the same or essentially the same peripheral configuration and size as the side walls 47 and 48, with the partition wall being parallel to the side walls 47 and 48. The partition wall 49 can have its peripheral or perimeter edges joined to the enclosure walls 43, 44, 45 and 46. In particular, the front peripheral edge of partition wall 49 can be joined to the front wall 43, the back peripheral edge of partition wall 49 can be joined to the back wall 44, the top peripheral edge of partition wall 49 can be joined to the top wall 45, and the bottom peripheral edge of partition wall 49 can be joined to the bottom wall 46. The partition wall 49 is preferably a rigid metal plate, most preferably aluminum. The peripheral edges of the partition wall 49 can be joined to the enclosure walls 43, 44, 45 and 46 in any suitable manner including welding. The seam or joint joining the peripheral edges of the partition wall 49 to the enclosure walls 43, 44, 45 and 46 can be disposed entirely within the interior of the enclosure 12 so as not to be visible or exposed along the exterior of the enclosure. However, the seam or joint joining the peripheral edges of the partition wall 49 to the enclosure walls could be partly or entirely visible or exposed along the exterior of the enclosure 12. The partition wall 49 could be formed integrally, unitarily or monolithically with either plate component part 56 or 58.

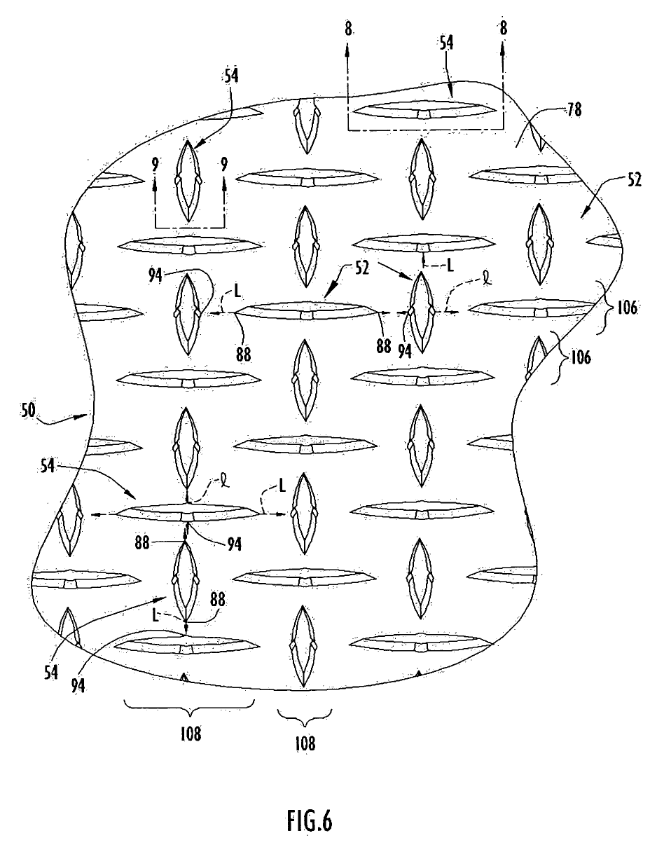

The plate component 50 is best illustrated in FIGS. 6-9. The plate 52 of plate component 50 is a solid plate or sheet having a planar lower surface 76, a planar upper surface 78 parallel to the lower surface 76, and a uniform thickness T between the planes of the lower and upper surfaces 76 and 78. The lower surface 76 faces the interior of the enclosure 12 when the plate component 50 is used to form the walls 43, 44, 45, 46, 47, and 48 of the enclosure 12 as explained above, and the lower surface 76 may thusly be considered the interior surface of the plate 52. The treads 54 of plate component 50 are disposed on the upper surface 78, which faces to the exterior of the enclosure 12 when the plate component 50 is used for the walls 43, 44, 45, 46, 47 and 48 of the enclosure 12. The upper surface 78 may thusly be considered the exterior surface of the plate 52.

The treads 54 are identical to one another except for their directional orientation on the plate 52 as explained further below. Accordingly, the description provided herein for a single tread 54 is applicable to all of the treads 54. The tread 54 is solid and includes a top surface 80 raised from the upper surface 78 of plate 52, a peripheral side wall 82 extending angularly outwardly from the peripheral or perimeter edge of the top surface 80 to the upper surface 78 of the plate 52, and a base 84 at which the tread is joined to the upper surface 78. The base 84 has a periphery or perimeter corresponding to the periphery or perimeter of the lower edge of the side wall 82 which intersects the upper surface 78 of the plate 52. The peripheral or perimeter edge of the top surface 80 follows the periphery or perimeter of the base 84 but is inwardly spaced from the periphery or perimeter of the base 84 due to the side wall 82 extending angularly outwardly from the top surface 80 to the upper surface 78. The periphery or perimeter of base 84 defines a footprint for the tread 54 on the upper surface 78 of the plate 52. The top surface 80 is planar and parallel to the upper surface 78 of the plate 52, and the tread 54 has a uniform thickness t between the plane of top surface 80 and the plane of upper surface 78. The plate thickness T defines a minimum thickness for the plate component 50, and the combined thickness (T+t) of the plate and tread defines a maximum thickness for the plate component 50.

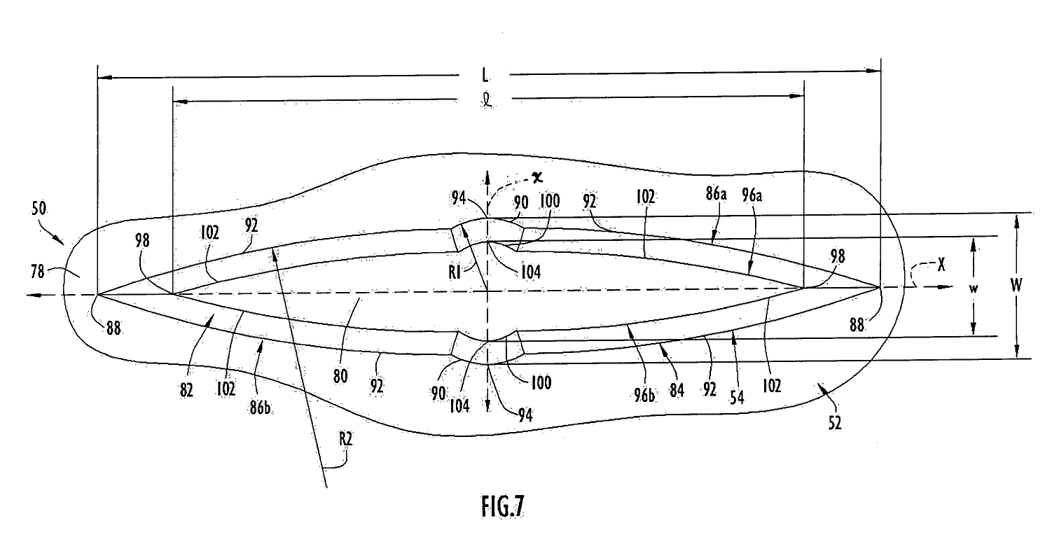

The periphery of base 84 can be considered a modified diamond configuration defined by first and second base side edges 86a and 86b that meet one another at opposed base end points 88. The base end points 88 are aligned with one another along a major axis X bisecting the tread 54 lengthwise. The tread 54 has an overall or maximum length L between the base end points 88 along the major axis X, which is also the central longitudinal axis of the tread 54. The first and second base side edges 86a and 86b are mirror images of one another on opposite sides of the major axis X, with each base side edge 86a and 86b comprising a central segment 90 between a pair of end segments 92. The central segment 90 of each base side edge 86a and 86b has opposed ends respectively joined to inner ends of the end segments 92 of the base side edge. The central segments 90 are arcuate or continuously curving between the inner ends of the end segments 92 to which they are joined. The end segments 92 of each base side edge 86a and 86b are arcuate or continuously curving from their inner ends to outer ends of the end segments 92 which terminate at the base end points 88. The outer ends of the end segments 92 for base side edge 86a meet the outer ends of the corresponding end segments 92 for base side edge segment 86b at the base end points 88. The curvature of each central segment 90 between its opposed ends is greater than the curvature of each end segment 92 between its inner and outer ends, the end segments 92 being more gently curved than the central segments 90. As shown in FIG. 7 for the base side edge 86a, the central segment 90 has a radius of curvature R1 less than or smaller than the radius of curvature R2 for the end segments 92.

The central segments 90 of tread 54 are bisected by a minor axis x of tread 54 which bisects the tread 54 widthwise. The minor axis x is perpendicular to the major axis X and it intersects the major axis X at the center of the tread 54 mid-way between base end points 88. The base end points 88 are thusly located the same distance from minor axis x but on opposite sides thereof. The tread 54 has an overall or maximum width W between base side points 94 on central segments 90 along the minor axis x. The base side points 94 are located the same distance from the major axis X but on opposite sides thereof, with the center of tread 54 being mid-way between the base side points 94 along the minor axis x.

The peripheral edge of top surface 80, which is also the periphery or perimeter of the upper edge of side wall 82, follows the periphery of base 84 in that it is parallel or substantially parallel to the periphery of base 84. The peripheral edge of top surface 80 is thusly defined by first and second top surface side edges 96a and 96b that meet one another at opposed top surface end points 98 along major axis X. The distance between the top surface end points 98 along major axis X corresponds to the minimum length l of tread 54 which is smaller than the overall or maximum length L. The top surface side edges 96a and 96b are parallel or substantially parallel to the corresponding base side edges 86a and 86b. Each top surface side edge 96a and 96b thusly comprises a central segment 100 between a pair of end segments 102 as described above for the base side edges 86a and 86b. The central segments 100 have the same or substantially the same curvature as the central segments 90, and the end segments 102 have the same or substantially the same curvature as the end segments 92. The top surface 80 has a width w, less than the maximum width W, between top surface side points 104 on central segments 100 along the minor axis x, the width w defining the minimum width of tread 54.

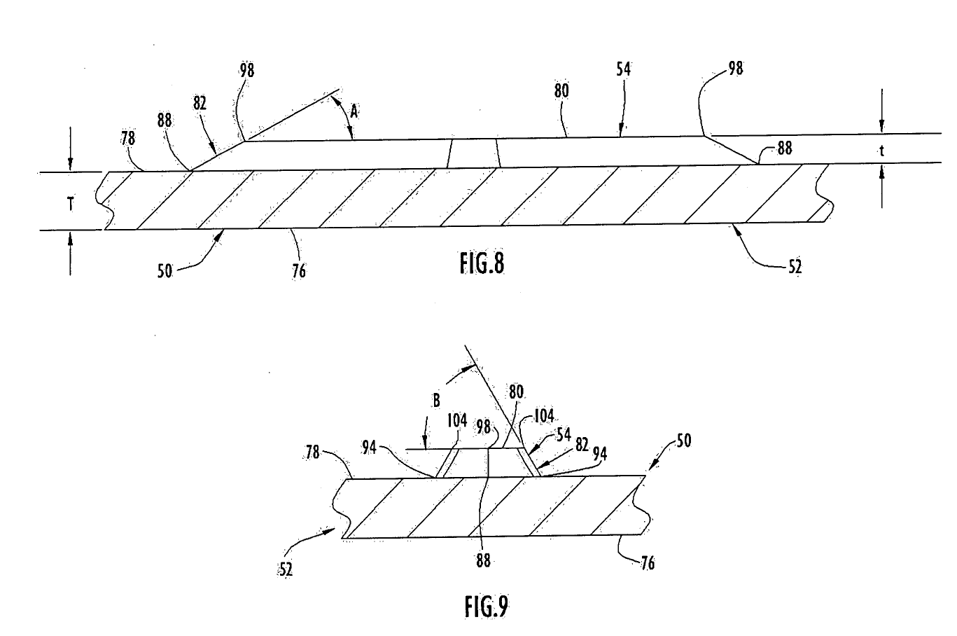

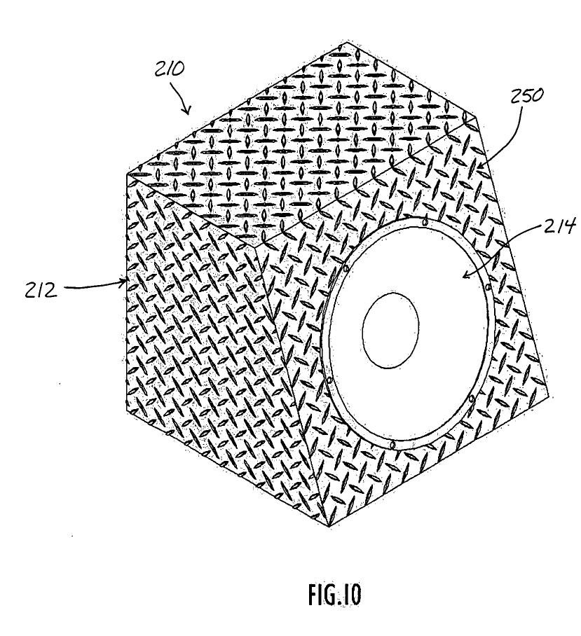

The side wall 82 between top surface end points 98 and the corresponding base end points 88 defines an angle A with the plane of top surface 80 as shown in FIG. 8. As shown in FIG. 9, side wall 82 between top surface side points 104 and the corresponding base side points 94 defines an angle B with the plane of top surface 80. Angle A is less than angle B such that the side wall 82 is more steeply angled at the side points 94, 104 and central segments 90,100 of the tread 54 and is less steeply angled at the end points 88, 98 and end segments 92,102 of the tread 54.

The plate 52 and treads 54 of plate component 50 are formed integrally, unitarily or monolithically such that the plate component 50 is an integral and unitary, monolithic one-piece component. As pointed out above, the plate component 50 is solid metal throughout its entirety and, preferably, is solid aluminum throughout its entirety. The plate component 50 is rigid and not resilient.

In a preferred embodiment, the thickness t of tread 54 is or is about one third the combined thickness (T+t) of the plate 52 and tread 54. Also, the thickness t of tread 54 is or is about one half the thickness T of plate 52. In the preferred embodiment, the thickness T of plate 52 is or is about ⅛ inch, and the thickness t of tread 54 is or is about 1/16 inch for a combined thickness (T+t) of or about 3/16 inch. However, it would be possible for the thickness T of plate 52 to be in the range of 1/32 inch to ½ inch depending on the weight of speakers 14 and the structural strength required for the enclosure 12. The overall or maximum width W of the tread 54 is in the range of or about ⅓ to ¼ the overall or maximum length L. In the preferred embodiment, the overall width W is or is about 5/16 inch and the overall length L is or is about 1 1/16 inches to 1 3/16 inches and, preferably, 1 3/16 inches. Where the overall length L is or is about 1 3/16 inches, the minimum length l at top surface 80 is or is about 1 inch. Where the overall width W is or is about 5/16 inch, the minimum width w at top surface 80 is or is about 3/16 inch. In the preferred embodiment, angle A is or is about one half angle B. Preferably, angle A is or is about 30° and angle B is or is about 60°.

As best seen in FIG. 6, the treads 54 are arranged on the upper surface 78 of plate 52 in a tread pattern comprising a plurality of rows 106 extending in parallel and a plurality of columns 108 extending perpendicular to the rows 106. Each row 106 is made up of a plurality of evenly spaced treads 54 wherein alternating treads of the row have their major axes L perpendicular to one another. Accordingly, treads of the row 106 which have their major axes L extending vertically or up and down in parallel alternate with treads of the row which have their major axes L extending horizontally or side to side, the major axes L of the horizontally extending treads being coaxial with the minor axes I of the vertically extending treads. Also, the base end points 88 of the horizontally extending treads of the row 106 are equally spaced from the base side points 94 of adjacent vertically extending treads of the row. Each column 108 is made up of a plurality of evenly spaced treads 54 in which alternating treads of the column have their major axes L perpendicular to one another. Treads of the column 108 which have their major axes L extending horizontally or side to side in parallel alternate with treads of the column which have their major axes L extending vertically or up and down, the major axes L of the vertically extending treads being coaxial with the minor axes I of the horizontally extending treads. The base end points 88 of the vertically extending treads of the column 108 are equally spaced from the base side points 94 of adjacent horizontally extending treads of the column. In a preferred embodiment, the spacing between the end points 88 of horizontally extending treads of row 106 and the side points 94 of adjacent vertically extending treads of row 106 is or is about ¼ inch. Likewise, the spacing between the end points 88 of vertically extending treads of column 108 and the side points 94 of adjacent horizontally extending treads of column 108 is or is about ¼ inch. As best shown in FIGS. 1-3, each wall of the enclosure can be formed from the plate component 50 so that the columns and rows of treads 54 run diagonal to the length and width of the wall.

FIG. 10 illustrates an alternative speaker enclosure 212 made from plate component 250 and which is similar to enclosure 12 except that enclosure 212 is shown mounting a single speaker 214 and is shown without a vent to form a single sealed or non-vented speaker unit 210. In speaker unit 210, the sound emanating from the rear end of speaker 214 is isolated by the enclosure 212 from the sound that emanates from the front end of speaker 214, and the speaker unit 210 operates in the same manner as conventional sealed or non-vented speaker units. The non-vented enclosure 212 can be designed to mount more than one speaker 214 and, where enclosure 212 mounts two speakers 214, the speaker unit 210 will be a dual sealed or non-vented speaker unit. The enclosure 212 with a single speaker 214 can be provided with a vent or port as described above for speaker unit 10, in which case the speaker unit 210 will be a single vented speaker unit.

The external dimensions of enclosures 12, 212 will vary in accordance with the size and number of speakers which are to be mounted to the enclosure and whether or not the speaker unit formed with the enclosure is to be a vented or non-vented speaker unit. As an example, in a dual vented speaker unit having speakers ten inches in diameter, the enclosure can have a width of or about twenty-eight inches, a height of or about fourteen inches, a depth of or about eleven inches along the top wall, and a depth of or about thirteen inches along the bottom wall; the centers of the openings formed in the front wall to mount the speakers can be located about six inches inwardly from the left and right side peripheral edges, respectively, of the front wall and about six inches upwardly from the bottom peripheral edge of the front wall; and the vents can be about three inches in diameter and about eight and six-tenths inches in length mounted in holes in the front wall having centers located about two and one half inches down from the top peripheral edge of the front wall and about two and one half inches inwardly from the left and right side peripheral edges, respectively, of the front wall. As another example, in a dual non-vented speaker unit having ten inch diameter speakers, the enclosure can have a width of or about twenty-four inches, a height of or about twelve inches, a depth of or about nine inches along the top wall, and a depth of or about eleven inches along the bottom wall.

In the speaker enclosures of the present invention the plate components 50, 250 forming the walls of the enclosures are of varying or non-uniform thickness, having areas of lesser thickness T and areas of greater thickness (T+t). The treads 54,254, which provide the thickness t, rigidify and strengthen the plates 52,252, which provide the thickness T. The added strength and rigidity imparted to the plates 52,252 by the treads 54,254 allow the thickness T of plates 52,252 to be reduced and allow the overall thickness (T+t) to be reduced while retaining the structural rigidity and strength needed to support the speakers and to effectively amplify and transmit sound. Accordingly, the plate thickness T and the overall thickness (T+t) of the plate component 50,250 can be thinner than the walls of uniform thickness found in many comparable speaker enclosures, particularly those made from wood materials. The speaker enclosures of the present invention can therefore be made lighter in weight, using less material, and at reduced cost. As an example, speaker enclosures made pursuant to the present invention have been found to be about 30% lighter in weight than comparable enclosures made from ¾ inch MDF (medium density fiberboard). The reduction in wall thickness achievable in the speaker enclosures of the present invention also permit the external dimensions of the enclosures to be reduced, thereby reducing the size of the footprint and the corresponding surface area on a support surface needed to support the enclosure. Reducing the external dimensions of the enclosures also allows the volume of space needed to accommodate the enclosures to be minimized. These footprint size and volume size reductions are important for vehicle use, where support surface space and volumetric space are both limited and at a premium. The footprint size and volume size reductions obtainable with the speaker enclosures of the present invention may make it possible for a vehicle to accommodate a speaker unit having larger size speakers than normally could be accommodated in the vehicle.

On a functional level, the speaker enclosures of the present invention provide greater sound amplification than comparable conventional speaker enclosures for louder and better sound output. The aluminum plate component 50,250 is heat and cold tolerant, which is particularly advantageous when the enclosures are placed in vehicles. The plate component 50,250 resists cracking, warping, and thermal expansion and contraction which are common problems of speaker enclosures made from wood material. The plate component 50,250 is a good dissipater of heat, thereby prolonging the life of the speaker units in general and the speakers in particular. Where the bottom wall of the enclosure is supported on a support surface, the treads of the plate component 50,250 in contact with the support surface may serve to elevate or separate the exterior surface of the plate of the bottom wall from the support surface, thereby enhancing heat dissipation and air flow between the plate and the support surface. Elevation or separation of the bottom wall plate from the support surface may also serve to protect the bottom wall plate from any potentially damaging substances that may be present on the support surface. The treads in contact with the support surface increase the friction between the bottom wall and the support surface to better hold the speaker unit in place on the support surface than enclosures which have walls with smooth exterior surfaces. The increased immobility obtained with the speaker enclosures of the present invention is particularly beneficial for vehicle use where the speaker enclosures are routinely subjected to forces from vehicle movement.

The speaker enclosures of the present invention and speaker units incorporating such enclosures can be assembled or produced using fewer steps, parts and materials than many conventional speaker units and enclosures. Simple welded joints or seams can be used to join the enclosure walls. The strength provided by the welded seams is structurally superior to that provided where mechanical fasteners or connectors such as screws are used to join the enclosure walls. The welded seams permit the enclosures to be assembled using less time and labor than that required for assembly of enclosures using mechanical fasteners or connectors. The welded seams are reliably air-tight and eliminate the need for sealants to be used to seal the seams joining the enclosure walls.

The plate component 50,250 imparts greater aesthetic appeal and interest to the speaker enclosures of the present invention. The treads of the plate component 50,250 provide a multi-dimensional textural effect for greater aesthetic distinction. Speaker enclosures made from the plate component 50,250 convey an impression of greater weight and ruggedness in spite of their lighter weight. The presence of the treads on the exterior surface of the plate makes it less likely that scratches or other surface imperfections on the exterior surface of the plate will be visually obvious, thereby prolonging an attractive appearance.

Inasmuch as the present invention is subject to various modifications and changes in detail, it is intended that the subject matter described above be considered illustrative only and not be taken in a limited sense.

What is claimed is:

1. An audio speaker enclosure for mounting an audio speaker, said enclosure comprising
a housing including a plurality of walls enclosing an interior, an opening in one of said walls for mounting a front end of an audio speaker with a rear end of the speaker disposed in said interior, each of said walls being made of an aluminum plate component comprising a plate having an interior surface facing said interior of said housing and an exterior surface facing to an exterior of said housing, and a plurality of raised treads on said exterior surface of said plate, said plate having a uniform thickness between said interior surface and said exterior surface, each of said treads including a top surface having a peripheral edge, a side wall extending angularly outwardly from said peripheral edge of said top surface to said exterior surface of said plate, and a base at which a lower peripheral edge of said side wall is joined to said exterior surface of said plate, each of said treads having a thickness between said top surface and said exterior surface of said plate, said plate component comprising areas of lesser thickness defined by said thickness of said plate and areas of greater thickness defined by the combined thickness of said plate and said treads, said plate and said treads being formed monolithically of solid aluminum.

2. The audio speaker enclosure recited in claim 1 wherein said thickness of said treads is about ⅓ said combined thickness of said plate and said treads.

3. The audio speaker enclosure recited in claim 1 wherein said thickness of said treads is about ½ said thickness of said plate.

4. The audio speaker enclosure recited in claim 1 wherein said thickness of said treads is about 1/16 inch and said thickness of said plate is about ⅛ inch.

5. The audio speaker enclosure recited in claim 1 wherein each of said treads is bisected lengthwise by a major axis and is bisected widthwise by a minor axis, each of said treads has a maximum length between end points of said base along said major axis and has a maximum width between side points of said base along said minor axis, said maximum width being in the range of about ⅓ to ¼ said maximum length.

6. The audio speaker enclosure recited in claim 5 wherein said maximum length is about 1 3/16 inches and said maximum width is about 5/16 inch.

7. The audio speaker enclosure recited in claim 5 wherein each of said treads has a minimum length between end points of said peripheral edge of said top surface along said major axis and a minimum width between side points of said peripheral edge of said top surface along said minor axis.

8. The audio speaker enclosure recited in claim 7 wherein said top surface is planar and said side wall is disposed at an angle to the plane of said top surface, said angle being greater at said side points than at said end points.

9. The audio speaker enclosure recited in claim 8 wherein said angle at said end points is about ½ said angle at said side points.

10. An audio speaker enclosure for mounting an audio speaker, said enclosure comprising
a housing including a plurality of walls enclosing an interior, an opening in one of said walls for mounting a front end of an audio speaker with a rear end of the speaker disposed in said interior, each of said walls being made in its entirety from a solid metal plate component comprising a plate having an interior surface facing said interior of said housing and an exterior surface facing to an exterior of said housing, and a plurality of raised treads on said exterior surface of said plate, each of treads comprising a top surface having a peripheral edge, a side wall extending angularly outwardly from said peripheral edge of said top surface to said exterior surface of said plate, and a base at which a lower peripheral edge of said side wall is joined to said exterior surface of said plate, said lower peripheral edge of said side wall being symmetrical to a major axis bisecting said tread lengthwise and being symmetrical to a minor axis perpendicular to said major axis and bisecting said tread widthwise, said lower peripheral edge including first and second base side edges which are mirror images of one another on opposite sides of said major axis, said first base side edge having opposed ends respectively joined to opposed ends of said second base side edge at base end points along said major axis, each of said first and second base side edges having a curved central segment between a pair of curved end segments, said end segments having a radius of curvature and said central segments having a radius of curvature smaller in size than said radius of curvature of said end segments, each of said treads having a maximum length between said base end points and a maximum width between base side points of said first and second base side edges, respectively, along said minor axis.

11. The audio speaker enclosure recited in claim 10 wherein said peripheral edge of said top surface is at least substantially parallel to said lower peripheral edge of said side wall.

12. The audio speaker enclosure recited in claim 10 wherein said treads are disposed on said exterior surface of said plate in rows and columns, each of said rows comprising a plurality of evenly spaced treads in which said major axes of alternating treads of said row are perpendicular to one another, each of said columns comprising a plurality of evenly spaced treads in which said major axes of alternating treads of said column are perpendicular to one another.

13. The audio speaker enclosure recited in claim 12 wherein adjacent treads of each row are spaced apart about ¼ inch and adjacent treads of each column are spaced apart about ¼ inch.

14. The audio speaker enclosure recited in claim 10 wherein said walls have peripheral edges joined by welding to form said housing.

15. The audio speaker enclosure recited in claim 10 wherein said housing includes a front wall, a back wall, a top wall, a bottom wall, a left side wall and a right side wall, said opening is formed in said front wall, and further including an aperture in said back wall and an electrical connector mounted in said aperture for electrical connection with the speaker and with an external sound source.

16. The audio speaker enclosure recited in claim 15 and further including a subwoofer audio speaker having a rear end disposed in said interior and a front end disposed in said opening, said front end being secured to said housing to form an audio speaker unit.

17. The audio speaker enclosure recited in claim 16 and further including a hole in said front wall and a vent mounted in said hole to establish communication between said interior of said housing and the environment external to said housing for passage of sound waves that emanate from said rear end of said speaker to reinforce sound waves that emanate from said front end of said speaker.

18. The audio speaker enclosure recited in claim 15 wherein said front wall has first and second openings for respectively receiving the front ends of first and second audio speakers with the rear ends of the first and second speakers disposed in said interior, said back wall has first and second apertures for respectively mounting first and second electrical connectors for electrical connection with the first and second speakers, respectively, and with the external sound source, and said front wall has first and second holes for mounting first and second vents to establish communication between said interior of said housing and the environment external to said housing for passage of sound waves that emanate from the rear ends of the respective first and second speakers and further including a partition wall in said interior dividing said interior into first and second compartments for respectively accommodating the rear ends of the first and second speakers.

19. An audio speaker enclosure for mounting an audio speaker, said enclosure comprising
a housing including a front wall, a back wall, a top wall, a bottom wall, a left side wall and a right side wall enclosing an interior, an opening in said front wall for receiving a front end of an audio speaker with a rear end of the audio speaker disposed in said interior, said housing being formed from a plurality of metal plate component parts each having an initially planar condition and being bent from said initially planar condition to form a plurality of said walls, said plate component parts having peripheral edges joined by welding to form said housing, each of said plate component parts being made in its entirety of solid aluminum and comprising a plate having an interior surface facing said interior of said housing and an exterior surface facing to an exterior of said housing, and a pattern of raised treads on said exterior surface.

20. The audio speaker enclosure recited in claim 19 wherein said housing is formed from two of said plate component parts, one of said plate component parts being bent from said initially planar condition to form said front wall, said back wall and said top wall, the other of said plate component parts being bent from said initially planar condition to form said bottom wall, said left side wall and said right side wall.
